(19) United States
(12) Patent Application Publication
(10) Pub. No.: US 2013/0023319 A1
(43) Pub. Date: Jan. 24, 2013

(54) Variant of Texas Hold 'Em Poker

(71) Applicant: Roger M. Snow, Las Vegas, NV (US)

(72) Inventor: Roger M. Snow, Las Vegas, NV (US)

(21) Appl. No.: 13/631,816

(22) Filed: Sep. 28, 2012

Related U.S. Application Data
(63) Continuation-in-part of application No. 13/455,742, filed on Apr. 25, 2012.
Application No. 13/455,742 is a division of application No. 11/156,352, filed on Jun. 17, 2005, now abandoned.

(51) Int. Cl. A63F 13/10

(52) U.S. Cl. 463/13

(57) ABSTRACT

A variant game of Hold 'Em poker allows for rules of play of one or all of players being allowed to remain in game with an option of checking or making specific wagering amounts in first play wagers, being limited in the size of subsequent available play wagers or prohibited from making additional play wagers if a first play wager has been made, being limited in the size of available later play wagers if a first or earlier play wager has been made, and having the opportunity for at least two and as many as three or four distinct opportunities in the stages in the play of a hand to be able to make one or more play wagers.

### CROSS-REFERENCE TO RELATED APPLICATION

This application is a continuation-in-part of U.S. patent application Ser. No. 13/455,742, filed Apr. 25, 2012, pending, which is a divisional of U.S. patent application Ser. No. 11/156,352, filed Jun. 17, 2005, abandoned, the disclosure of which is hereby incorporated herein by this reference in its entirety.

### FIELD

The present invention relates to wagering games, casino table wagering games, casino table playing card wagering games, computer-implemented wagering games, and variants of casino table wagering games that use poker ranks in determining outcomes.

### BACKGROUND

Many different wagering games presently exist for use in both home and casino environments. Such games should necessarily be exciting, uncomplicated and easy to learn so as to avoid frustrating the players. Designing new games that meet these criteria and are sufficiently different from old games as to entice players to play the new game is a particular challenge.

### SUMMARY

A new variant game of Hold 'Em poker allows for rules of play of one or all of players being allowed to remain in the game with an option of checking or making specific wagering amounts in first play wagers. For purposes of this disclosure, “checking” means staying in the game without making an additional wager. Games disclosed herein have limits and prohibitions regarding the size of the bets that can be made as the game progresses. Play wagers if made earlier in the game can be multiples of later-made play wagers. For example, players may be given the opportunity for making play wagers during at least two different stages of play and may have the opportunity to make a play wager in as many as three or four distinct stages in the play of a single hand. As the game progresses, more information is available to the player and consequently the permitted amounts bet decrease with increasing information.

The games described in this disclosure can offer side bets that are based on an entire Hold 'Em hand because players may check or make play wagers and in embodiments do not fold. When there is no folding of hands, an entire game can be considered in resolving side bets.

One embodiment of the game is based upon a 5-card hand that uses poker-style rankings. In this game, the player is dealt or otherwise receives less than a full hand, and, using one or more community cards, makes the best possible 5-card hand they can. Providing more than one community card may provide additional betting opportunities as the community cards are revealed. The game in one embodiment is based on five-card poker hand rankings, and in other embodiments other poker hand ranking systems are used, such as three-card poker rankings, four-card poker rankings and seven-card poker rankings.

### BRIEF DESCRIPTION OF THE FIGURES

FIG. 1 shows a perspective view of a prior art format for an automated gaming system.

FIG. 2 shows an overhead view of a prior art format for an automated gaming system.

FIG. 3 shows a side view of a prior art format for an automated gaming system.

FIG. 4 shows a block schematic of the electronic configuration of a prior art animated gaming system.

FIG. 5 shows a perspective view of a format for an automated gaming system according to one embodiment.

FIG. 6 shows a schematic of a gaming engine useful in the practice of one embodiment.

FIG. 7 shows a schematic of a player station useful in one embodiment.

FIG. 8 shows a schematic of an embodiment of a game display useful in the practice of one embodiment.

FIG. 9 shows three typical wagering layouts for a casino card table Hold 'Em game according to one embodiment.

FIG. 10 shows a flow diagram for a process according to one embodiment.

FIG. 11 is a schematic block diagram of a gaming system for implementing wagering games according to an embodiment.

FIG. 12 illustrates a block diagram of a gaming system that offers wagering games according to one embodiment.

FIG. 13 is a block diagram of a gaming system providing for live dealer play for a user at a remote user device according to one embodiment.

FIG. 14 is a high-level block diagram of a computer for acting as a gaming system according to one embodiment.

### DETAILED DESCRIPTION

The terms “gaming,” “gambling,” or the like, refer to activities, games, sessions, rounds, hands, rolls, operations, and other events related to wagering games such as web games, casino games, card games, dice games, and other games of chance for which wagers may be placed by a player. In addition, the word “wager,” “bet,” “bid” or the like, refer to any type of wagers, bets or gaming ventures that are placed on random events, whether of monetary or non-monetary value. Points, credits, and other items of value may be purchased, earned, or otherwise issued prior to beginning the wagering game. In some embodiments, purchased points, credits, or other items of value may have an exchange rate that is not one-to-one to the currency used by the user. For example, a wager may include money, points, credits, symbols, or other items that may have some value related to a wagering game. Wagers may be placed in wagering games using real currency, virtual credits, or other countable elements.

The gaming methods described in this disclosure may be played in a number of different formats such as live action casino table gaming format with a live dealer and real playing cards and chips, or with various automated formats with partial (e.g., wagers only) or complete (wagers, cards, dealer, etc.) automation of the format. Such formats include traditional video gaming apparatus and modern multi-player platforms such as those described in U.S. patent application Ser. Nos. 10/764,995, 10/764,994 (now U.S. Pat. No. 7,661,676), and 10/764,827, each filed on Jan. 26, 2004, which are hereby incorporated by reference, the apparatus of each of which is described in more detail in the disclosure below.

A basic format (whether on a table or automated device, with computer, processor, monitor, cash/credit/token receptors, etc.) of play involves a player making at least a first ante wager to enter the game against a dealer's hand. The dealer and players each receive at least one card. In one example of the game, the dealer provides two cards to each player that made an ante wager and two cards to the dealer. The player cards may be face up or face down. Providing the player cards face down may be preferable to the players and also preferable to the house. Typically the dealer and players each receive the same number of cards, a game can include dealing unequal numbers of cards to the dealer and players, which will alter the house advantage. For example, giving the dealer three cards instead of two cards and allowing the dealer to discard one card would provide a greater advantage to the house.

One example of the game play described herein is referred to as “ULTIMATE TEXAS HOLD 'EM”™. To begin the game, players make at least one ante wager or preferably at least two initial equal wagers, an ante wager and a blind wager. The ante wager is mandatory to participate in this embodiment of the game. In one form of the game, the blind wager is also mandatory. A bonus wager is optional (called the “trips” wager) and is based on the player's resulting five-card hand having an ultimate hand rank of at least three-of-a-kind, from a best five-card hand. Other higher-ranking hands also pay bonus payouts according to a pay table listing winning hand outcomes and corresponding payout odds. The minimum hand of three-of-a-kind is selected based on the mathematics of the game and is a matter of design choice. In this example of the game, the dealer deals each player two hole cards face down. The dealer receives a two-card dealer hand of two hole cards (face down). This two-card hand may be dealt at the same approximate time as the player hand or nearer the end of the game, after all wagers have been placed and the player has seen all available cards.

In one embodiment, after viewing the hole cards, players may make a single play bet that may be made at different predetermined stages in the progression of the hand. Furthermore, an amount of the play bet may vary with the stage of progression of the hand of the game. In one example, the player can make the play bet only once, and can make the wager at up to four different stages in the progress of the game. With each passing step, the amount of the permitted wager decreases. The player is, therefore, rewarded for risking larger amounts earlier in the game, when less information about the outcome of the hand is available for the player. As the player learns additional information about whether the player is likely to win the wager, the player is able to wager less money on the play bet.

The game rules also set limits on the amount of each possible play bet wager. For example, in the early stages of a round, the play bet can be chosen from within a range, such as 1× and 10×, 1× to 6× or 1× to 4× the ante, for example. At the last stage, the play bet may be limited to no more than 1× the ante. Depending upon the stage of the game when the play bet is made, with earlier stages allowing larger play bets, and later stages allowing for relatively smaller play bets, higher payouts can be made to a player who puts more at risk when less information is available.

In this example, after seeing their two hole cards, players have a specific choice—check (remaining in the game) or making a specific play wager amount (e.g., precisely a 4× wager). In other examples, rather than a specific play wager amount, the player may choose a bet within a range of wagers (e.g., between 1× and 10×). The “X” indicates a multiple of the ante wager. In one embodiment, players may not fold. The player allowed to see additional card(s) that may well improve an apparently weak hand and decide at that time to place a play bet. When no folding is permitted, the range of payouts on the side bets can be increased because it becomes possible to use a complete hand of cards to consider in determining winning outcomes.

The dealer then displays (deals or reveals) the first set of community cards, in one embodiment three community cards out of a total of five. In other embodiments, more or fewer than five cards are dealt as community cards and the initial display of community cards may also be adjusted.

In one example of the game, before any community cards are revealed, the players know only two out of seven cards (i.e., the player's initial hand) the player may use to form a hand. After the initial set of three community cards is revealed, players know the identity of five out of seven. When the fourth community card is revealed, players know six out of seven cards and when the last community card is turned over, they know all seven and can pick the best five cards. The first three cards in Hold 'Em games is typically referred to as the “flop.” The fourth card is referred to as the “turn card” or simply “the turn,” and the fifth community card is referred to as the “river card” or simply “the river.”

After seeing the first set of community cards the players have the following options. If they have not already made the first wager (e.g., the specific amount wager such as the 4× play bet), they may again check (remaining in the game without wagering at this time) or make a second play wager of an amount less than the amount of the first play wager, such as a 2× or 3× the ante wager for the second play wager. If the player made the original first play wager, e.g., the 4× play wager, the player may not make an additional play wager and must check for the remainder of the game. In this example of the game, players cannot fold. In some embodiments, additional play wagers may be made in smaller amounts for the player who has made an original play wager. Typically, no action, other than a check, can be made by the player who made the original play (4×) wager at this point, although in other examples of the game, folding or a surrender can also be allowed.

Players may also have a choice to play a range of play wagers, such as from 1× to 4× the ante in the original play wager, and 1× to 3× the ante in the second play wager, etc.

The dealer then displays additional community cards, up to the total number of community cards, depending on the embodiment, such as both of the remaining community cards (the turn and the river). Another embodiment would allow an additional wager with the fourth but not the fifth common card revealed where the player has not previously made a play wager. An example of such a wager could be 2× or 3× the ante or a range of 1× to up to 3× the ante. In one embodiment, play wagers are allowed after the first two player hands are revealed, after the flop is revealed, after the fourth card is revealed and after the fifth community card is revealed, for a total of four play bet opportunities.

Players now know all seven of the cards from which they may make their best five-card hand. If the player has made no play wagers in the previous steps, the player may have an additional opportunity to make a play wager (in one embodiment, 1× of the ante) or fold. If the player has made a previous play wager, the player may check. In one embodiment, a player who has previously made a play wager may also fold or may be allowed to surrender a portion of the player's bet.

The dealer then reveals his two hole cards to determine the dealer's best five-card hand using the dealer's hole cards and the community cards. In one example, players are free to use any five of the seven available cards to form a player's hand. Players may alternately be required to use their hole cards, or the three highest ranking community cards, or four community cards and one player hole card. Many other minor rule variations for generating a five-card hand may be implemented without departing from the scope of this disclosure.

The dealer's best five of seven cards hand is compared against each player's best five of seven cards hand to determine head-to-head winners. In one embodiment, no dealer or player qualifying step is necessary to play the game. In an alternative, the dealer and/or players must qualify with a predetermined minimum card ranking in order to play. If the dealer, for example, does not qualify with any pair or better, for example, the ante wagers are returned to the players. However, the play wagers, blind bets and any side wagers are resolved in the normal manner. Play bets are resolved in the normal manner. All winning payouts on side bets are still paid, regardless of whether the dealer qualifies. All automatic bonus payouts are also made. When there is no dealer or player qualification step, then the dealer hand is compared to player hands and the highest ranking hand wins the round. Ante bets are paid even money. Blind bets are paid odds for certain high-ranking hands, and side bets are paid odds according to a pay table.

Players also win 1:1 on play bets when their hand beats the dealer's hand and ties are pushes. The player loses the ante bet and all play bets when the player's hand has a lower rank than the dealer's hand.

The blind bet is typically equal to the ante but in other embodiments can be multiples of the ante. The blind bet may be mandatory. The blind bet wins when the player has a predetermined winning hand rank, for example, a flush or higher, and the player's hand beats the dealer's hand. The blind bet loses when the player's hand loses. The blind bet pushes when the player's hand ties the dealer's hand. The blind bet also pushes when the player's hand is less than a flush but beats the dealer's hand.

Distinct pay tables may be provided for the blind and trips wagers, such as:

Blind payouts

| | |
|---|---|
| Royal flush | 200:1 |
| Straight flush | 50:1 |
| Four-of-a-kind | 10:1 |
| Full house | 2:1 |
| Flush | 3:2 |

Trips payouts

| | |
|---|---|
| Royal flush | 50:1 |
| Straight flush | 40:1 |
| Four-of-a-kind | 30:1 |
| Full house | 8:1 |
| Flush | 7:1 |
| Straight | 4:1 |
| Three-of-a-kind | 3:1 |

The following example of a hand of play of the ULTIMATE TEXAS HOLD 'EM™ poker embodiment is provided below. In ULTIMATE TEXAS HOLD 'EM™, players place at least an ante and a blind bet of equal value, as well as an optional trips bet. Two cards are initially dealt to each player as well as the dealer. Five community cards are used, which are revealed in two steps. The first step reveals the first three community cards, and the second step reveals the last two community cards. Until all of the community cards are revealed, players may check (place no bets) or may place a play bet. The players in ULTIMATE TEXAS HOLD 'EM™ may place only a single play bet during the course of the game. As cards are revealed, the amount allowed for the play bet decreases. Prior to revealing any community cards, the players in ULTIMATE TEXAS HOLD 'EM™ may make a play bet of either 4× or 3× the ante bet or the player may check. After the first three community cards are revealed, players may make a play bet of exactly 2× the ante bet or the player may check. When the remaining two community cards are revealed, players may make a play bet of exactly 1× the ante bet or the player may fold. If the player has placed a play bet, the player's poker hand is determined by making the best 5-card poker hand among the player's two cards and the five community cards. The dealer's poker hand is determined by making the best 5-card poker hand among the dealer's two cards and the five community cards. Bets are resolved based the player and dealer's 5-card poker hand and, for the blind and trips bet, based on a pay table for qualifying hands. An example follows:

| Dealer Activity | Player 1 Activity | Player 2 Activity |
|---|---|---|
| Awaits wagers | $5 ante, $5 blind | $10 ante, $10 blind, $5 trips |

The dealer's partial hand of two cards is dealt face down to the dealer, and each of Player 1 and Player 2 receives their two partial hands of two cards each. The cards may be face down, face up or partially exposed for the players.

| Dealer Activity | Player 1 Activity | Player 2 Activity |
|---|---|---|
| Cards Hidden | 10 [symbol] Jack [symbol] | King♡ King♦ |

After viewing their initial partial two-card hands, the players may make their decision on the first play wager. Player 1's hole cards are good, but do not warrant a large wager. If given a choice between a check up to the extreme of 4× the ante, Player 1 would elect to check. He chooses to check because he does not have enough information to determine whether his hand is strong enough to win. Player 2's hand is very good, although it still has not reached a bonus level payout (e.g., three-of-a-kind or better, or at least a straight), but the hand probably warrants the maximum first play wager of 4× the ante or an additional $40.00 wagered. In this embodiment, Player 2 may not make any further wagers, and checks until the completion of the round.

After conclusion of this first play wager round of wagering, the flop (three community cards) is shown. Those cards in this Example are:
King [symbol] , Queen♦ and 7 [symbol] .

These cards provide Player 1 with an outside (two-way) straight draw and two running cards for a club flush, with two cards remaining to be drawn. This hand is considered a relatively good hand. Player 1, who has not yet made a play bet, might, therefore, elect to make the maximum second play wager of 2× the ante, or $10.00. As noted earlier, in this embodiment Player 2 has no further wagers available, but would be happy with the flop, providing a rank of three-of-a-kind at this stage.

| Dealer Activity | Player 1 Activity | Player 2 Activity |
|---|---|---|
| Cards Hidden | $10 2X second play | $40, 4X first play |
| | opportunity | opportunity |

At this point, in the example method of play, the last two community cards are be revealed. In this example, the community cards are:
7♦ and 4♡.

At this point, the rank of Player 1's hand is a pair of sevens, and the rank of Player 2's hand is a full house.

As both players have made play wagers at this time, if the rules limit player activity to a single play wager during the progress of a hand, no further play wagers may be made. If Player 1 had been conservative in the second play wager stage and checked, then Player 1 might be required to make a third play wager of 1× to remain in the game, may be allowed to check, or may be allowed to fold at this stage. Having made the earlier second play wager, then Player 1 would have no choice but to check at this point. If allowed, Player 2 might make an additional wagers.

At this point, the dealer would reveal the two cards in the dealer's partial hand. Although it is common for the dealer's two-card partial hand to have been dealt at the same time as the players' partial hands and to have been kept face down, as a security measure (preventing any possibility of those dealer cards having been exposed or partially exposed) the dealer's two cards might be dealt at the end of play, at this point in the play of the hand of the game.

The dealer's cards are 10♡ Jack♦. This dealer's hand is, in combination with the community cards, identical with the rank of Player 1's hand, so the ante wager is a push according to the rules of play. The blind bet loses.

Player 2's hand rank, as a full house, wins 1:1 on the ante wager ($10), wins 1:1 on the 4× first play wager ($40), wins 2:1 ($20) on the blind wager, and wins 8:1 ($40) on the trips wager for a total win of $110.

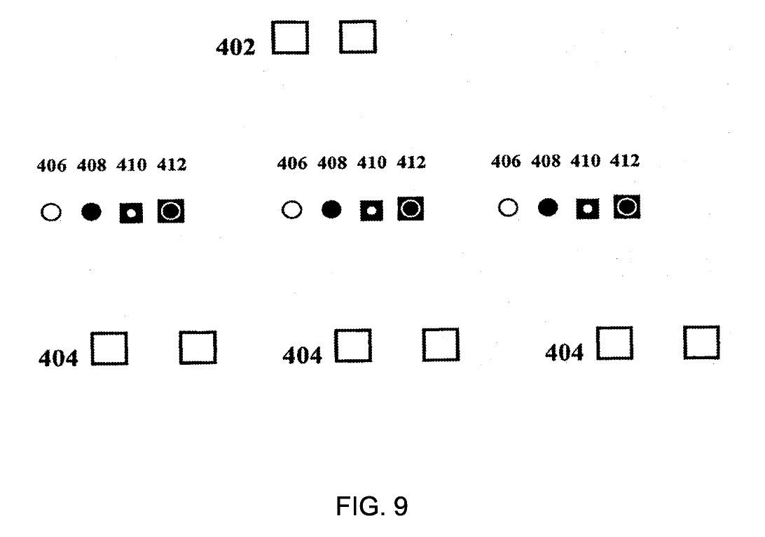

A betting layout for ULTIMATE TEXAS HOLD 'EM™ poker games is shown in FIG. 9. A dealer's hand 402 of two cards is shown, and players' hands 404 for three players is also shown. Each player's position is provided with four separate betting areas for the ante wager 406, the blind wager 408, the trips wager 410 and the play wager 412. As there may be only a single play wager made during the play of the game, in these embodiments a single play wager betting area 412 is provided. The presence or absence of a token or coin in that area 412 at any time may indicate the status and opportunity of players to make play wagers and the amount of play wagers at the various stages of the games. For example, when the flop has been exposed, if there is no bet present in area 412, then the lack of a play wager indicates that a) the player can still make a play wager, and b) that the player is known to have specific ranges or amounts of the second play wager available to that player. In contrast, if a bet is present, then the player is known to have no second play wager available at that stage of the game.

Additional betting areas may be used if additional wagers are allowed. For example, the game rules might allow four different opportunities to make a play bet and provide a different betting circle (and betting limits) for each state of the game. For example, if a player has placed the 4× first play wager, the rules of the game may be modified to allow for additional wagers at the same or at lower odds than the earlier play wagers. If the rules of the game allow for multiple play wagers, it would be desirable to provide multiple betting circles on the layout. For example, if Player 2 in the example had received a flop of a king and a pair, or two additional kings, he might be allowed to make an additional wager in one embodiment. The rules of the game might allow for one additional play wager at the same 1:1 odds, or allow subsequent wagers to be placed at lower odds, such as 1:2 odds, returning an additional 50% on the second play wager.

Other embodiments for are also contemplated. For example, a four-card version of the game could be offered in which each player and the dealer receive one card, and the dealer deals three or four community cards. Players can bet up to 3× the ante after viewing the first card, up to 2× the ante after seeing the first two community cards, and up to 1× the ante after seeing all of the cards.

An interesting aspect is that in a form of play as described above, players either check or raise during various stages of play of a Hold 'Em style poker game, but the players are not permitted to fold until the end. This rule enables play of a side bet wager based on the composition of the entire final hand of cards. In typical Hold 'Em games, players fold before all of the cards are revealed, making it impossible to base side bet results on a five-card hand, for example. Five-card outcomes have a wider variety of probabilities and allow for game designs offering higher payouts for less frequently occurring hands, such as obtaining a five-card royal flush, for example.

Another feature of this embodiment is that players are permitted to place wagers on a hand after all of the community cards are revealed. This feature allows a player to know the player's five-card hand prior to placing a final bet and may have appeal to a player who prefers certainty about the player's hand strength before making a bet.

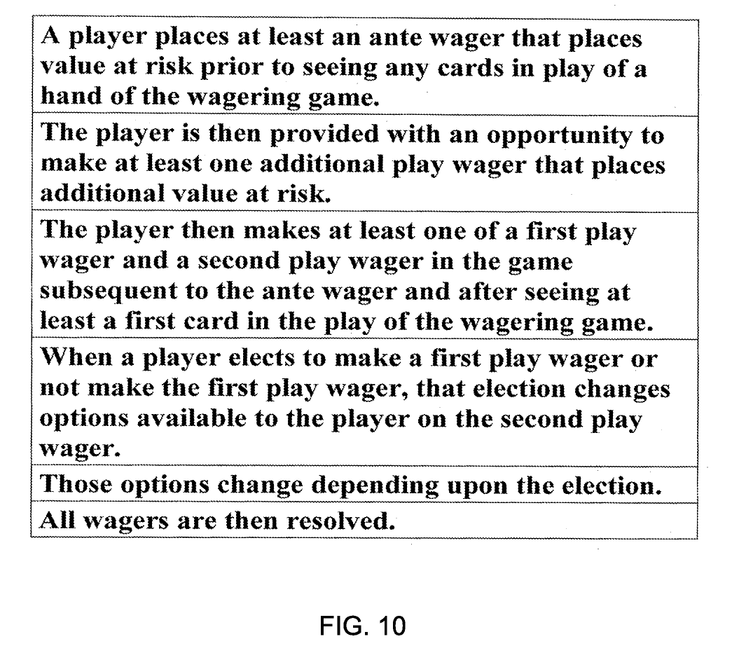

FIG. 10 shows a flow diagram for a process according to one embodiment. As shown by the diagram, a player initially places at least an ante wager that places the ante wager value at risk prior to dealing any cards. Next, the player is provided an opportunity to make at least one additional play wager that places additional value at risk. The player may make at least one of a first play wager and a second play wager in the game subsequent to the ante wager, and after seeing at least a first card. After deciding whether to make the first play wager, the election of the first play wager changes the options available to the player on the second play wager. For example, after making the first play wager, the player may be required to check at the second play wager opportunity, while if the player does not make the first play wager, the player may be allowed to make the second play wager opportunity. Based on the first play wager election, options for the second play wager change. Any remaining cards are dealt and the wagers are then resolved.

The games of the present disclosure may be implemented as live table games, television or cable game show games, video poker gaming machine platforms, hand-held games for play, multiple player interactive wagering platform games (with kiosk formats, single player screens, community screens, and/or banks of seats for players with a common dealer screen), cell phone games, games downloadable from the internet, parlor games, games executed on personal computers, palm pilots, play stations and the like. Each of the above game applications is a way to play the game.

A gaming system that can be used to practice the games described herein comprises a table and a dealer “virtual” video display system positioned for view by players seated at the table. The table may seat at least two players up to the amount of players that can be configured about the table and have a view of the dealer video display system. Typically, each gaming system will have available at least four player positions, with space determinations considered as to whether there would be 4, 5, 6 or 7 player positions. It is possible to have a completely circular dealer display (e.g., holographic display in a cylindrical centerpiece) and have players distributed around the entire periphery. A surface of the table will include a generally continuous common display surface for showing all player hands, community cards, dealer hands and any other cards or game pieces used to play the game for any purpose, and, where there are touch screen player controls, for displaying the player touch screen controls. A majority of the table surface comprises a video monitor in one embodiment. Where there are no touch screen controls, the table surface may include player control panels at each player station near the continuous display surface. The use of a continuous display surface offers some significant advantages in simulating or recreating a standard card table surface. Cards may be readily viewed by other players at a table, which is standard in table games and adds to player enjoyment. Individual monitors, especially where slanted toward the individual players, make such table-wide card reading difficult. The use of the full screen (continuous) display also allows for better animation to be provided, such as displaying virtual images of cards moving to the player and “virtual” chips being placed on the table when wagers are indicated. For purposes of this disclosure, the term “virtual” means a graphical video representation of a real object or person, such as a dealer, cards and chips, for example.

The individual player positions preferably have a separate intelligence at each player position that accepts player input and communicates directly with a game engine (main game computer or processor). The intelligence is preferably an intelligent board that can process information. For purposes of this disclosure, the term “intelligent” refers to the ability to execute code, either provided in the form of software or hardware circuits or both. Such processing may at least comprise some of signal converting (e.g., signals from player card readers, credit deposit, currency readers, coin readers, touch screen signals, control panel signals) into a signal that can be included in an information packet and interpreted by the main game computer when the signal is sent. Communication between the intelligence at each player position is direct to the main game computer and may be by self-initiated signal sending, sequenced polling by the main game computer (e.g., each position communicates directly to the main game computer in turn), timed communication, or any other order of communication that is direct between the intelligence and the main game computer.

One form of communication between the main game computer and player station computers is by means of self-initiated signal sending. There is essentially a single main game computer that contains video display controls and programs for both the dealer display and the table top display, audio controls and programs, game rules (including storage of multiple games if intended to be available on the machine), random number generator, graphic images, game sequence controls, security systems, wager accounting programs, external signaling and audit functions, and the like. In other embodiments, the above functions are divided between a main processor and one or more additional processors. The intelligence at each player position speeds up the performance of all aspects of the game by being able to communicate directly with the main game computer and being able to process information at the player position rather than merely forwarding the information in raw form to the main game computer. Processing player information at player positions frees up resources for use by the main processor or processors.

A card game system may also include a suitable data and control processing subsystem that is largely contained within a main control module supported beneath the tabletop. The control and data processing subsystem includes a suitable power supply for converting alternating current from the power main as controlled by a main power switch. The power supply transforms the alternating line current to a suitable voltage and to a direct current supply. Power is supplied to a power distribution and sensor/activity electronics control circuit. Commercially available power switching and control circuits may be provided in the form of a circuit board that is detachable, and plugs into a board receptacle of a computer mother board or an expansion slot board receptacle. A main game controller motherboard may include a central microprocessor and related components well-known in the industry as computers using Intel brand PENTIUM® microprocessors and related memory or intelligence from any other manufacturing source. A variety of different configurations and types of memory devices can be connected to the motherboard. Of particular interest is the inclusion of two flat panel display control boards connected in expansion slots of the motherboard. Display control boards are each capable of controlling the images displayed for the dealer video display and for each of the player position display areas on the continuous display screen on the table and other operational parameters of the video displays used in the gaming system. More specifically, the display control boards are connected to player bet interface circuits for the player stations. This arrangement also allows the display control boards to provide necessary image display data to the display electronic drive circuits associated with the dealing event program displays and the dealer display.

The motherboard and/or the individual player intelligent boards also include a serial port that allows stored data to be downloaded from the motherboard to a central casino computer or other additional storage device. In one example, each player board communicates directly with the casino computer system. This allows card game action data to be analyzed in various ways using added detail, or by providing integration with data from multiple tables so that cheating schemes can be identified and eliminated, and player tracking can be maintained. Player performance and/or skill can be tracked at one table or as a compilation from gaming at multiple tables, as by using BLOODHOUND™ security software marketed by Shuffle Master, Inc., which may be incorporated into this automated gaming system. Additionally, player hand analysis can be performed. The motherboard and/or individual player intelligent boards may also have a keyboard connection port that can be used to connect a larger format keyboard to the system to facilitate programming and servicing of the system.

Although the system shown does not require features illustrated for receiving automated player identification information, such features can alternatively be provided. Card readers such as used with credit cards or other identification code reading devices can be added in the system to allow or require player identification in connection with play of the card game and associated recording of game action by one of the processors. Such a user identification interface, for example, a card reader located at each player station, can be implemented in the form of a variety of magnetic card readers commercially available for reading user-specific identification information. The user-specific information can be provided on specially constructed magnetic cards issued by a casino, or magnetically coded credit cards or debit cards frequently used with national credit organizations such as VISA®, MASTERCARD®, AMERICAN EXPRESS®, casino player card registry, banks and other institutions. The information could also be provided on other writable media, such as an RFID chip with writable memory, or bar coding, as just a few examples.

Alternatively, it is possible to use so-called smart cards to provide added processing or data storage functions in addition to mere identification data. For example, the user identification could include coding for available credit amounts purchased from a casino. As a further example, the identification card or other user-specific instrument may include specially coded data indicating security information such as would allow accessing or identifying stored security information that must be confirmed by the user after scanning the user identification card through a card reader. Such security information might include such things as file access numbers that allow the central processor to access a stored security clearance code that the user must indicate using input options provided on displays using touch screen displays. A still further possibility is to have participant identification using a fingerprint image, eye blood vessel image reader, or other suitable biological information to confirm identity of the user that can be built into the table. Still further, it is possible to provide such participant identification information by having the pit personnel manually code in the information in response to the player indicating his or her code name or real name. Such additional identification could also be used to confirm credit use of a smart card or transponder. All or part of the functions dedicated to a particular player station are controlled by the player station intelligence in one embodiment. Additionally, each player station intelligence may be in communication with a casino accounting system.

It should also be understood that the continuous screen can alternatively be provided with suitable display cowlings or covers that can be used to shield display of card images from viewing by anyone other than the player in games where that is desirable. This shielding can also be effected by having light-orientation elements in the panel, and some of these light-orientation elements are electronically controllable. In this manner, the processor can allow general viewing of cards in games where that is desirable or tolerated, and then alter the screen where desired. These types of features can be provided by nanometer, micrometer or other small particulate or flake elements within a panel on the viewing area that are reoriented by signals from the processor. Alternatively, liquid crystal or photo chromatic displays can be used to create a screening effect that would allow only viewers at specific angles of view from the screen area to view the images of cards. Such an alternative construction may be desired in systems designed for card games different from blackjack, where some or all of the player or dealer cards are not presented for viewing by other participants or onlookers. Such display covers or cowlings can be in various shapes and configurations as needed to prevent viewing access. It may alternatively be acceptable to use a player-controlled switch that allows the display to be momentarily viewed and then turned off. The display can be shielded using a cover or merely by using the player's hands. Still further, it is possible to use a touch screen display that would be controlled by touch to turn on and turn off. Similar shielding can be used to prevent others from viewing the display.

A review of the figures will assist in describing various embodiments.

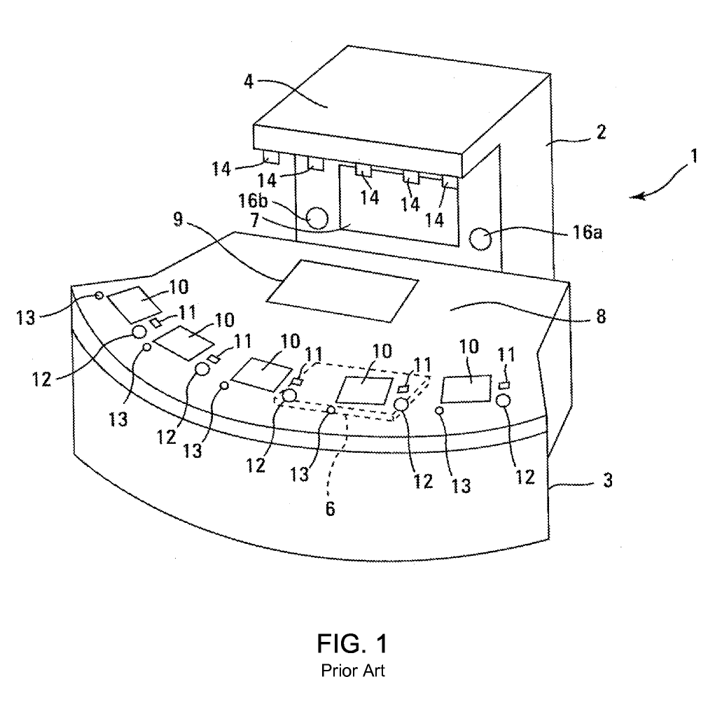

FIG. 1 shows a fully automated gaming table 1 of the prior art, as disclosed in U.S. Patent Application 2003/0199316, which is hereby incorporated by reference. The system 1 comprises a vertical upright display cabinet 2 and a player bank or station cluster arrangement 3. The vertical display cabinet 2 has a viewing screen 7 on which images of the virtual dealer are displayed. The top 8 of the player bank arrangement 3 has individual monitor screens 10 for each player position, as well as tabletop inserted coin acceptors 11, and player controls 12 and 13. There is a separate and larger dealer's hand screen 9 on which dealer cards are displayed in a format large enough for all players to view. Speakers 16a and 16b are provided for sound transmission and decorative lights 14 are provided.

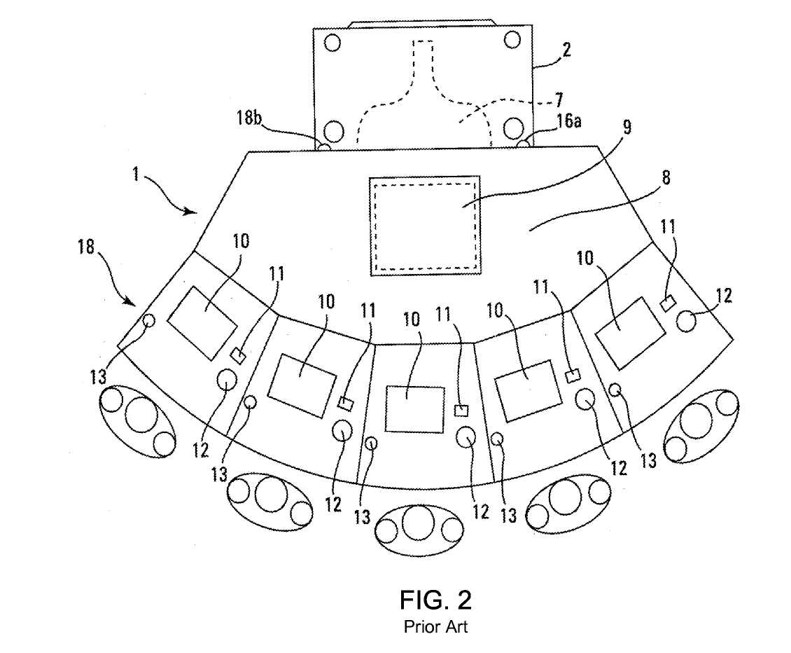

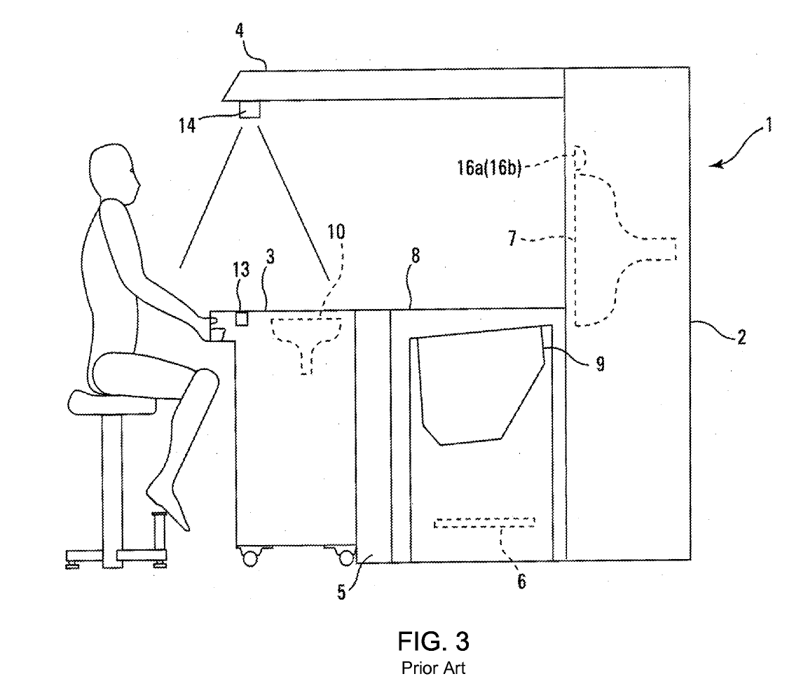

FIG. 2 shows an overhead view of the same prior art automated gaming system 1 with the viewing screen 7 shown more clearly as a CRT monitor. It can also be seen that each player position has to form an arc cut into the semicircular player seating area 18. FIG. 3 shows a side view of the same prior art automated gaming system of FIGS. 1 and 2 where the orientation of the three different types of CRT monitors 7, 9 and 10 are shown.

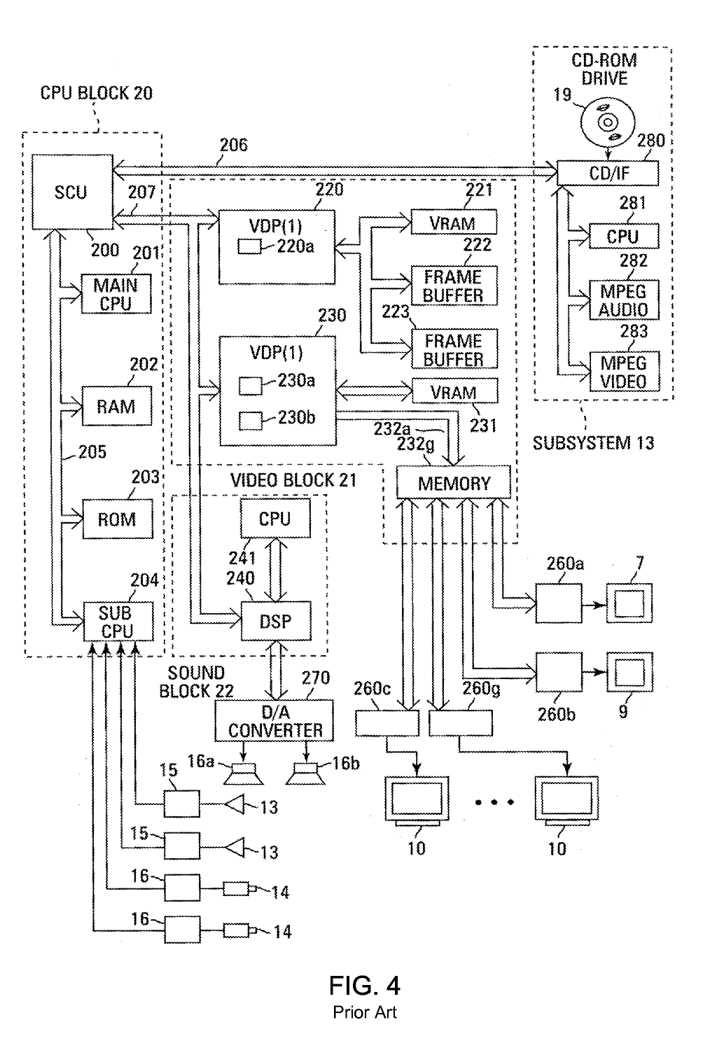

FIG. 4 shows the schematic circuitry of a prior art automated system as disclosed in 2003/0199316. FIG. 4 is a block diagram of processing circuitry in the game device of FIG. 1. The game device housing comprises a CPU block 20 for controlling the whole device, a picture block 21 for controlling the game screen display, a sound block for producing effect sounds and the like, and a subsystem for reading out CD-ROM.

The CPU block 20 comprises an SCU (System Control Unit) 200, a main CPU 201, RAM 202, RAM 203, a sub-CPU 204, and a CPU bus 205. The main CPU 201 contains a math function similar to a DSP (Digital Signal Processing) so that application software can be executed rapidly.

The RAM 202 is used as the work area for the main CPU 201. The RAM 203 stores the initialization program used for the initialization process. The SCU 200 controls the busses 205, 206 and 207 so that data can be exchanged smoothly among the VEPs 220 and 230, the DSP 241, and other components.

The SCU 200 contains a DMA controller, allowing data (polygon data) for character(s) in the game to be transferred to the VRAM in the picture block 21. This allows the game machine or other application software to be executed rapidly. The sub-CPU 204 is termed an SMPC (System Manager & Peripheral Control). Its functions include collecting sound recognition signals from the sound recognition circuit 15 or image recognition signals from the image recognition circuit 16 in response to requests from the main CPU 201. On the basis of sound recognition signals or image recognition signals provided by the sub-CPU 204, the main CPU 201 controls changes in the expression of the character(s) appearing on the game screen, or performs image control pertaining to game development, for example. The picture block 21 comprises a first VDP (Video Display Processor) 220 for rendering TV game polygon data characters and polygon screens overlaid on the background image, and a second VDP 230 for rendering scrolling background screens, performing image synthesis of polygon image data and scrolling image data based on priority (image priority order), performing clipping, and the like. The first VDP 220 houses a system register 220a, and is connected to the VRAM (DRAM) 221 and to two frame buffers 222 and 223. Data for rendering the polygons used to represent TV game characters and the like is sent to the first VDP 220 through the main CPU 220, and the rendering data written to the VRAM 221 is rendered in the form of 16- or 8-bit pixels to the rendering frame buffer 222 (or 223). The data in the rendered frame buffer 222 (or 223) is sent to the second VDP 230 during display mode. In this way, buffers 222 and 223 are used as frame buffers, providing a double buffer design for switching between rendering and display for each individual frame. Regarding information for controlling rendering, the first VDP 220 controls rendering and display in accordance with the instructions established in the system register 220a of the first VDP 220 by the main CPU 201 via the SCU 200.

The second VDP 230 houses a register 230a and color RAM 230b, and is connected to the VRAM 231. The second VDP 230 is connected via the bus 207 to the first VDP 220 and the SCU 200, and is connected to picture output terminals Voa through Vog through memories 232a through 232g and encoders 260a through 260g. The picture output terminals Voa through Vog are connected through cables to the display 7 and the satellite displays 10.

Scrolling screen data for the second VDP 230 is defined in the VRAM 231 and the color RAM 230b by the CPU 201 through the SCU 200. Information for controlling image display is similarly defined in the second VDP 230. Data defined in the VRAM 231 is read out in accordance with the contents established in the register 230a by the second VDP 230, and serves as image data for the scrolling screens that portray the background for the character(s). Image data for each scrolling screen and image data of texture-mapped polygon data sent from the first VDP 220 is assigned display priority (priority) in accordance with the settings in the register 230a, and the final image screen data is synthesized.

Where the display image data is in palette format, the second VDP 230 reads out the color data defined in the color RAM 230b in accordance with the values thereof, and produces the display color data. Color data is produced for each display 7 and 9 and for each satellite display 10. Where display image data is in RGB format, the display image data is used as-is as display color data. The display color data is temporarily stored in memories 232a-232f and is then output to the encoders 260a-260f. The encoders 260a-260f produce picture signals by adding synchronizing signals to the image data, which is then sent via the picture output terminals Voa through Vog to the display 7 and the satellite displays 10. In this way, the images required to conduct an interactive game are displayed on the screens of the display 7 and the satellite displays 10.

The sound block 22 comprises a DSP 240 for performing sound synthesis using PCM format or FM format, and a CPU 241 for controlling the DSP 240. Sound data generated by the DSP 240 is converted into two-channel sound signals by a D/A converter 270 and is then presented to audio output terminals Ao via interface 271. These audio output terminals Ao are connected to the input terminals of an audio amplification circuit. Thus, the sound signals presented to the audio output terminals Ao are input to the audio amplification circuit (not shown). Sound signals amplified by the audio amplification circuit drive the speakers 16a and 16b. The subsystem 23 comprises a CD-ROM drive 19b, a CD-I/F 280, and CPU 281, an MPEG-AUDIO section 282, and an MPEG-PICTURE section 283. The subsystem 23 has the function of reading application software provided in the form of a CD-ROM and reproducing the animation. The CD-ROM drive 19b reads out data from CD-ROM. The CPU 281 controls the CD-ROM drive 19b and performs error correction on the data read out by it. Data read from the CD-ROM is sent via the CD-I/F 280, bus 206, and SCU 200 to the main CPU 201 that uses it as the application software. The MPEG-AUDIO section 282 and the MPEG-PICTURE section 283 are used to expand data that has been compressed in MPEG (Motion Picture Expert Group) format. By using the MPEG-AUDIO section 282 and the MPEG-PICTURE section 283 to expand data that has been compressed in MPEG format, it is possible to reproduce motion picture. It should be noted herein that there are distinct processors for the CPU block, video block, sound block, CD-ROM drive and memory with their independent PCUs. This requires significant computing power and still has dumb (no intelligence) player input components.

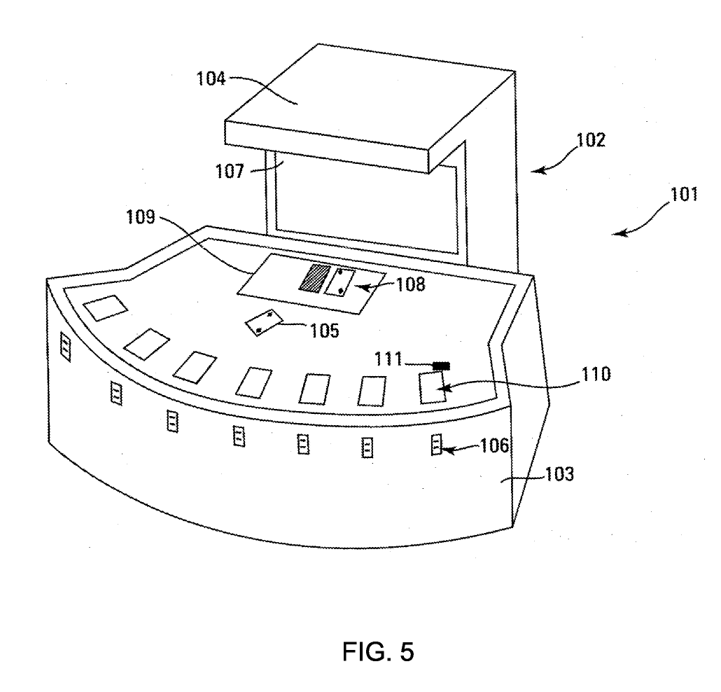

FIG. 5 shows an example of an automated table system 101 useful to practice the game play methods according to one embodiment. The system 101 has an upright dealer display cabinet 102 with a top 104 and the dealer viewing screen 107, which may be any form of display screen such as a CRT, plasma screen, liquid crystal screen, LED screen or the like. The player bank arrangement 103 has a continuous display screen 109 on which images of cards being dealt 105, dealer's cards 108, bets wagered 111 and touch screen player input functions 110 are displayed. Other player input functions may be provided on a panel 106, which might accept currency, coins, tokens, identification cards, player tracking cards, ticket in/ticket out acceptance, and the like.

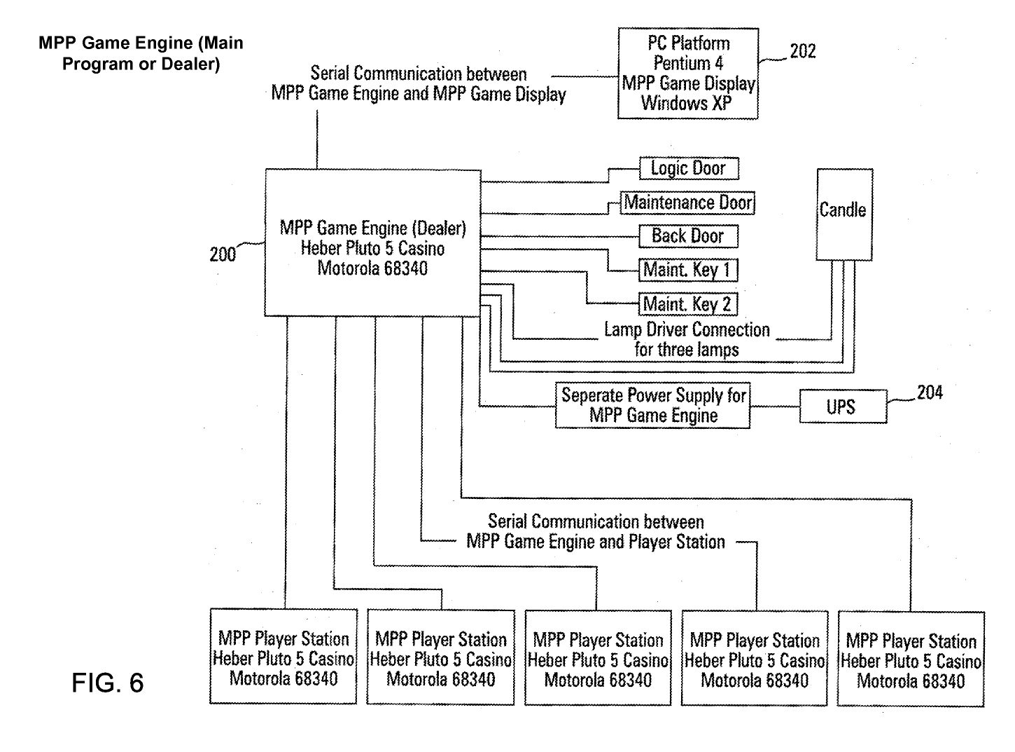

FIG. 6 shows an electronic/processor schematic for a MultiPlayer Platform (MPP) gaming system according to an embodiment. The MPP game engine (dealer) comprises a Heber Pluto 5 casino game board 200 (Motorola 68340 board) operating off the PC Platform PENTIUM® 4 MPP game display processor 202. The game display processor operates on a WINDOWS® XP platform. The respective subcomponents on the PENTIUM® 4 processor are labeled to show the apportionment of activity on the motherboard and the component parts added to the board. As is shown, the game engine has an uninterruptible power supply 204. The game display processor directs activity on the speakers, directs activities onto the MPP game service panel, and the plasma monitor card display. It is important to note that all communications are direct from the game display processor, freeing up resources available to the game engine processor.

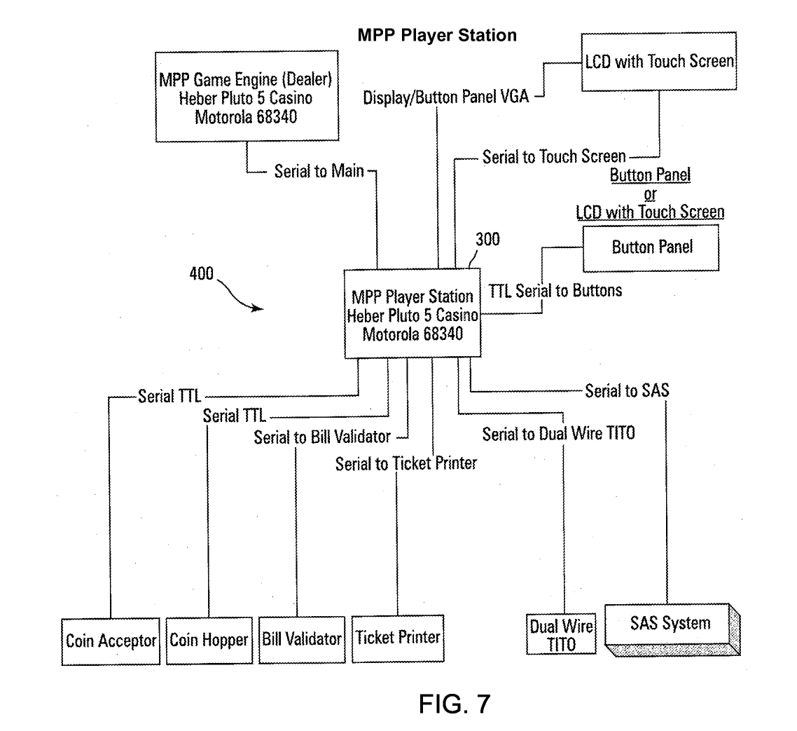

FIG. 7 shows the electronic/processing schematics of the MPP player station intelligence board (Heber Pluto 5 Casino, Motorola 68340), each of which player stations (one for each player position) is in direct connection to the MPP game engine (dealer), which is, in turn, directly connected to the PC platform (not shown in FIG. 7). Each intelligence board receives information for all player input systems specific to that player station, such as the shown coin acceptor, coin hopper, bill validator, ticket printer, touch screen and/or display button panel, dual wire ticket-in/ticket-out printing and SAS system (SAS is one exemplary standard communications protocol used by a number of casinos' central computer systems.)

The above-described architecture is also an improvement in providing a system with not only the intelligence at each player position, but also in redistributing processing capability for functions among various processing components within the gaming system. In one architectural format, all functions of the gaming engine, except for the player localized intelligence functions, are consolidated into a single PC (e.g., the PENTIUM® 4 shown in the figures). This would include all game functions, player video functions, dealer video functions, dealer audio functions, security, central reporting (to a casino's central computer, for example), currency and debit functions, alarm functions, lighting functions, and all other peripherals on the system, except for the localized player functions. Alternatively, all functions requiring communication with the casino's main computer system are located on the player station intelligent boards. In this system, the main game processor would talk directly with the player intelligent boards, preferably in the same novel communication format described below.

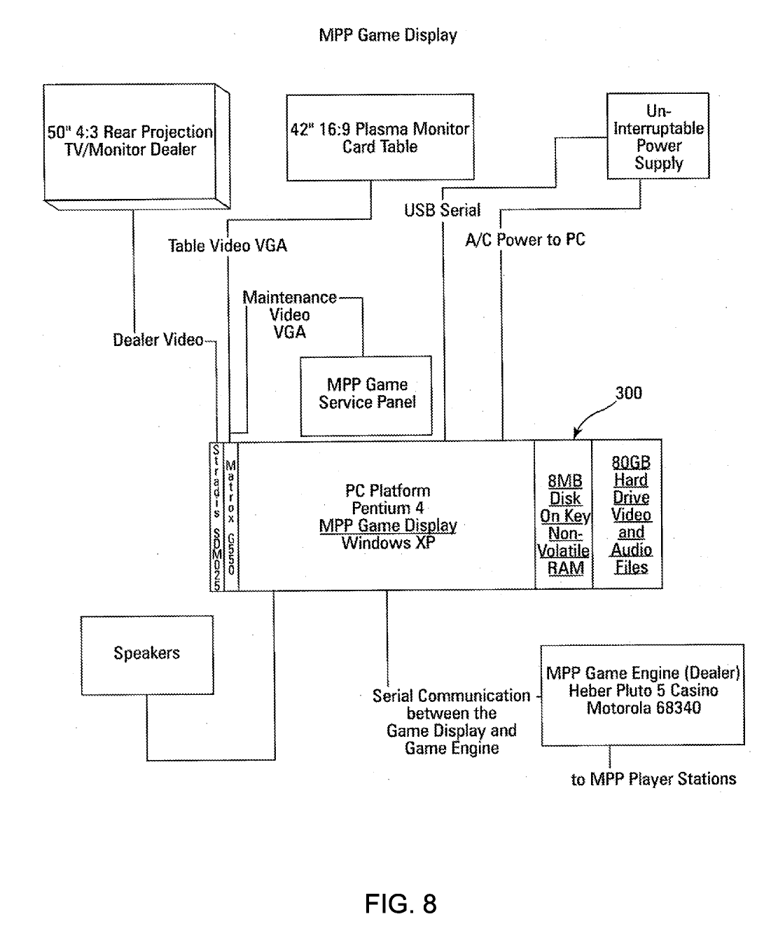

An alternative system is shown in FIGS. 6, 7 and 8, where there is a dealer engine processor intermediate the main game PC and the player intelligent boards. Both systems are a distinct improvement over the prior art, but with the higher power available for PCs and with the ease of programming a PC as opposed to an embedded system, the consolidation of the game functions and the ability of the main game engine to communicate with each of the player positions is enabled. As shown in FIG. 8, the game display processor 300 is preferably a PENTIUM® 4 PC and is separate from the main processor. With the player intelligent boards, the main game PC can receive packets of information from each player station as events occur rather than having to poll each player position on a regular basis 100 times to gain the specific information for each player input that may be made.

For the purposes of this disclosure, it will be understood that when a game and any actions associated with the game are described, that game and its rules and actions are also useable in an electronic version of the game (an electronic or on-line version of the game or games using the same set of rules and/or game play).

Gaming actions and rules such as accepting wagers, making payouts, dealing cards, selecting cards, and other actions associated with a player or a dealer include physical and electronic embodiments. Thus, when a description is given of a player or dealer taking a game related action, it is intended that the embodiments include action on a live gaming table, a virtual table or display, and the generation, transmission, and reception of such an action in an electronic form where player and dealer choices, selections, or other actions are received at an electronic interface. This further includes the results of a virtual dealer and virtual players, where the actions described are actually generated by a computer (typically associated with an on-line game). As an example, if dealing of a card is described herein, the description includes providing a card to be associated (associable) with the applicable position in the game, such as a player, dealer, or a community. Such dealing includes (but is not limited to): the dealing of a card by a dealer from a deck, shuffler, or other card source and the reception or placement of the card at a table location associable with a player, or reception directly by a player; or, the generation and transmission of an electronic indication of a card from a game play source or server to an electronic receiver, where the receiver may be at a table (virtual cards) including players and/or virtual players and/or a dealer or virtual dealer, at a public display in a casino, at a remote location (on-line or internet game play), or other locations, and also including the representation of a card on a display or displays, and, if applicable to the action described, an electronic reception of an indication that the card has been received, selected, or otherwise interacted with at a location associable with a player, or, associated with a virtual player.

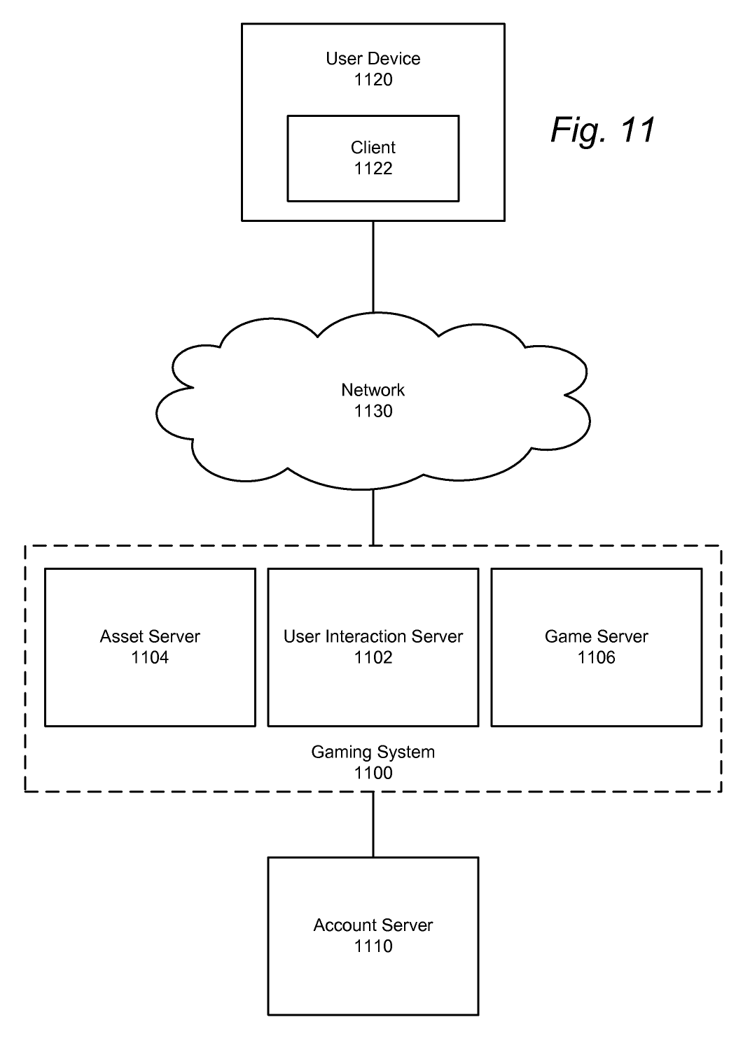

FIG. 11 is a schematic block diagram of a gaming system 1100 for implementing wagering games according to an embodiment. The gaming system 1100 enables end users to access wagering game content. Such game content may include, without limitation, various types of wagering games such as card games, dice games, big wheel games, roulette, scratch off games, and any other wagering game with a randomized element in determining wagering outcomes. Such games in may be played against the gaming system or against other end users. In particular, the gaming system 1100 allows users to play variants of the wagering games described above.

The wagering games supported by the gaming system 1100 may be operated with real currency or with virtual credits. For example, the real currency option may include traditional casino and lottery-type wagering games in which money or other items of value are wagered and may be cashed out at the end of a game session. The virtual credits option may include wagering games in which credits (or other symbols) may be issued to a player to be used for the wagers. For example, credits may be purchased by a player or issued through other methods. Although credits may be won or lost, the ability of the player to cash out the credits may be prevented. In other words, while the credits may be purchased, the credits in a play for fun option may be limited to non-monetary credits in terms of the ability of the player to extract cash or goods or services of monetary value out of the wagering game. Systems that operate play for fun games may include issuance of free credits. In some embodiments, a limited number free credits may be issued in order to entice players to play the games. Credits may be won or lost, but credit balances may not be cashed out. In exchange for identifying friends who may want to play, the system may issue additional credits. Often, additional credits may be issued after a period of time has elapsed to encourage the player to resume playing the game. The system may enable players to buy funds or additional game credits to allow the player to resume play. Objects of value may be awarded to play for fun players, which may or may not be in a direct exchange for credits. For example, the client may award a prize for a highest scoring play for fun player during a defined time interval.

The gaming system 1100 includes a gaming platform that establishes a portal for an end user to access a wagering game hosted by a game server 1106 through a user interaction server 1102. The user device 1120 communicates with a user interaction server 1102 of the gaming system 1100 using a network 1130. The user interaction server 1102 communicates with the game server 1106 and provides game information to the user. In some embodiments, a single user device communicates with a game provided by the game server 1106, while other embodiments may include a plurality of user devices 1120 configured to communicate and provide end users with access to the same game provided by game server 1106. In addition, a plurality of end users may access a single user interaction server 1102 or a plurality of user interaction servers 1102 to access game server 1106.

The user interaction server 1102 communicates with the user device 1120 to enable access to the gaming system 1100. The user interaction server 1102 allows a user to create and access a user account and interact with gaming server 1106. The user interaction server 1102 allows users to initiate new games, join existing games, and interface with games being played by the user.

The user interaction server 1102 may also provide a client 1122 for execution on the user device for accessing the gaming system 1100. The client 1122 provided by the gaming system 1100 for execution on the user device 1120 can comprise a variety of implementations according to the user device and method of communication with the gaming system 1100. In one embodiment, the user device 1120 connects to the gaming system 1100 using a web browser and the client 1122 executes within a browser window or frame of the web browser. In another embodiment, the client 1122 is a stand-alone executable on the user device 1120.

For example, the client 1122 may comprise a relatively small amount of script (e.g., JavaScript), also referred to as a “script driver,” including scripting language that controls an interface of the client 1122. The script driver may include simple function calls requesting information from the gaming system 1100. In other words, the script driver stored in the client 1122 may merely include calls to functions that are externally defined by, and executed by, the gaming system 1100. As a result, the client 1122 may be characterized as a “thin client.” As that term is used herein, the client 1122 may be little more than a script player. The client 1122 may simply send requests to the gaming system 1100 rather than performing logic itself. The client 1122 receives player inputs and the player inputs are passed to gaming system 1100 for processing and executing the wagering game. In other embodiments, the client 1122 comprises an executable rather than a script. As a result, the bulk of the processing of the game play is performed in the gaming system 1100. The client 1122 may receive intermediate data and final game outcome information from the gaming system 1100 for displaying on the end user's computer after such is determined by the game server 1106.

In another embodiment, the client 1122 implements further logic and game control methodology beyond the thin client described above. For example, the client 1122 may parse and define player interactions prior to passing the player interactions to the gaming system 1100. Likewise, when the client 1122 receives a gaming interaction from the gaming system 1100, the client 1122 may be configured to determine how to modify the display as a result of the gaming interaction. The client 1122 may also allow the player to change a perspective or otherwise interact with elements of the display which do not change aspects of the game.

The gaming system 1100 also includes an asset server 1104 which hosts various media assets (e.g., audio, video, and image files) that may be sent to the client 1122 for presenting the various wagering games to the end user. In other words, in this embodiment the assets presented to the end user are stored separately from the client 1122, and the client 1122 requests the assets appropriate for the game played by the user. For example, the client 1122 may call a function defined at the user interaction server 1102 or asset server 1104 which determines what assets are to be delivered to the client 1122 as well as how the assets are to be presented by the client 1122 to the end user. Different assets may correspond to the various clients that may have access to the game server 1106 or to different games to be played.

The game server 1106 is configured to perform game play methods and determine game play outcomes that are provided to the user interaction server 1102 to be transmitted to user device 1120 for display on the end user's computer. For example, the game server 1106 may include game rules for one or more wagering games, such that the game server 1106 controls the game flow for a selected wagering game, as well as the determining game outcomes, pay tables, and other game logic. The game server 1106 also performs random number generation for determining random game elements of the wagering game. The game server 1106 is typically separated from the user interaction server 1102 by a firewall or other method of preventing unauthorized access to the game server 1106 from the general members of the network 1130.

The user device 1120 presents a gaming interface to the player and communicates the user interaction to the gaming system 1100. The user device 1120 may be any electronic system capable of displaying gaming information, receiving user input and communicating the user input to the gaming system 1100. As such, the user device 1120 can be a desktop computer, a laptop, tablet computer, set-top box, mobile device, kiosk, terminal, or other computing device. The user device 1120 operates the client 1122 for connecting to the interactive gaming system 1100 as described above. The client 1122 may be a specialized application or may be executed within a generalized application capable of interpreting instructions from the interactive gaming system 1100, such as a web browser.

The client 1122 may interface with an end user through a web page, an application (e.g., a smartphone or tablet application), or other computer program in order to access the gaming system 1100. The client 1122 may be illustrated within a casino webpage (or other interface) indicating that the client 1122 is embedded into a webpage, which is supported by a web browser executing on the client device 1120.

The gaming system 1100 may be operated by different entities in one embodiment. The user device 1120 may be operated by a third party, such as a casino, that links to the gaming system 1100. Therefore, in some embodiments, the user device 1120 and client 1122 is operated by a different administrator than the operator of the game server 1106. In other words, the user device 1120 may be part of a third-party system that does not administer the game server 1106.

In another embodiment, the user interaction server 1102 and asset server 1104 are provided by a third-party system. For example, a gaming entity (e.g., a casino) may operate the user interaction server 1102 or user device 1120 to provide its customers access to game content managed by a different entity. In some embodiments, these functions are operated by the same administrator. For example, a gaming entity (e.g., a casino) may elect to perform each of these functions in-house, such as providing both the access to the user device 1120 and the actual game content and providing administration of the gaming system 1100.

The gaming system 1100 also communicates with external account servers 1110, optionally through another firewall. For example, the gaming system itself may not take wagers or issue payouts. In other words, the gaming system 1100 may facilitate online casino gaming, but may not be part of a self-contained online casino itself. Instead, the gaming system 1100 may facilitate the play of proprietary card game content owned and controlled by a company offering games and gaming products and services, such as Shuffle Master, Inc. Another entity (e.g., a casino) may operate and maintain its external account servers 1110 to take bets and make payout distributions. The gaming system 1100 may communicate with the account servers 1110 to verify the existence of funds for wagering, and instructs the account servers 1110 to execute debits and credits.

In some embodiments, the gaming system 1100 may take bets and make payout distributions, such as in the case where administrator of the gaming system 1100 operates as a casino. As discussed above, the gaming system 1100 may be integrated within the operations of a casino rather than separating out functionality (e.g., game content, game play, credits, debits, etc.) among different entities. In addition, for “play for fun” wagering games, the gaming system 1100 may issue credits, take bets, manage the balance of the credits according to the game outcomes, but may not permit payout distributions or be linked to play for fun account servers 1110 that permit payout distributions. Such credits may be issued for free, through purchase, or for other reasons, without the ability for the player to cash out. Such play for fun wagering games may be played on platforms that do not permit traditional gambling, such as to comply with jurisdictions that do not permit online gambling.

The gaming system 1100 may be configured using a distributed server architecture. For example, the game server 1106 may be include a plurality of servers (e.g., game rules server, deck server, game routing server, account server, asset server, etc.) that are logically separated to perform different functions for the wagering game. Additional features may be supported by the game server 1106, such as hacking and cheating detection, data storage and archival, metrics generation, messages generation, output formatting for different end user devices, as well as other features and operations. For example, the gaming system 1100 may include additional features and configurations as described in U.S. patent application Ser. No. 13/609,031, filed Sep. 10, 2012, and entitled “Network Gaming Architecture, Gaming Systems, and Related Methods,” the entire disclosure of which is incorporated herein by this reference.

The network 1130 enables communications between the user device 1120 and the gaming system 1100. A network may also connect gaming system 1100 and account server 1110 (not shown). In one embodiment, the network 1130 uses standard communications technologies and/or protocols. Thus, the network 1130 can include links using technologies such as Ethernet, 802.11, worldwide interoperability for microwave access (WiMAX), 3G, digital subscriber line (DSL), asynchronous transfer mode (ATM), InfiniBand, PCI Express Advanced Switching, etc. Similarly, the networking protocols used on the network 1130 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 1130 can be represented using technologies and/or formats including the hypertext markup language (HTML), the extensible markup language (XML), etc. In addition, all or some of links can be encrypted using conventional encryption technologies such as secure sockets layer (SSL), transport layer security (TLS), virtual private networks (VPNs), Internet Protocol security (IPsec), etc. In another embodiment, the entities can use custom and/or dedicated data communications technologies instead of, or in addition to, the ones described above. Depending upon the embodiment, the network 1130 can also include links to other networks such as the Internet.

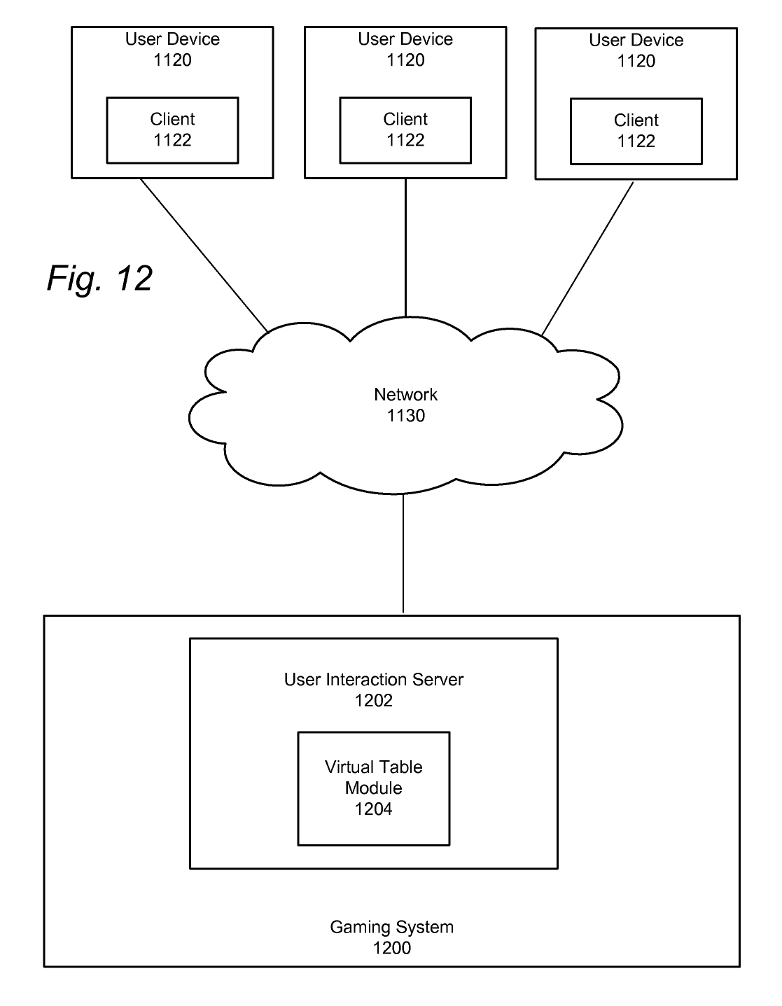

FIG. 12 illustrates a block diagram of a gaming system 1200 that offers wagering games according to one embodiment. The gaming system 1200 provides gaming services to a plurality of user devices 1120 in a similar manner to the gaming system 1100 described above with respect to FIG. 11. Accordingly, common components between gaming system 1200 and gaming system 1100 may include an asset server 1104, gaming engine 1106, and a communication with an account server 1110. The user interaction server 1202 provides similar functionality to user devices 1120 as provided by user interaction server 1102. User interaction server 1202 includes additional functionality using a virtual table module 1204 for providing a virtual table to the user devices 1120.

The virtual table module 1204 creates and manages virtual tables for use by the user devices 1120. A virtual table is a simulation of a table as may be used on a casino floor. As such, the virtual table allows a specific number of players to join a game hosted by the gaming system 1200. The game may be operated by the game server 1106. A lobby may be provided to the player of the user device 1120, allowing the user to browse various tables that may be joined by the player. Once a player joins a virtual table, the virtual table module 1204 provides a virtual table interface to the user device.

The virtual table interface provided by the virtual table module 1204 displays appropriate play areas to the user according to the game being played by the user. For example, a user choosing to play a game as described above, and shown with respect to FIG. 9 may be shown play areas for multiple players in the game. To take particular actions relative to the action in the game, the player takes action in gameplay areas associated with the particular player. In addition, when the dealer takes actions, the dealer's actions are relayed to each of the other players. In certain games, a player may take actions in the game simultaneously and in others the player must wait for the game's action to be on the player before the player may act. The virtual table interface provides the user the ability to view virtual actions taken by other players in addition to actions taken by the player himself. Using the virtual table module 1204, the gaming system 1200 provides a virtual experience to the user similar to play on a casino floor.

In addition to actions taken responsive to the gameplay, players may also view other information provided by the other players. For example, like sitting at a table in person, the players at the virtual table may chat with one another, for example via a chat interface, and optionally communicate with an audio connection if a microphone and speakers are available at the user devices 1120. In addition, for games where a player is provided a card or cards face-down, the player may also choose to reveal the player's card(s) to the other players at the table. Thus, the virtual table enables the players to engage in interactions with others players at the table as though the players were actually in person together at a table at the casino floor.

In one embodiment, the virtual table module 1204 provides the players with an image of a virtual dealer. The virtual dealer provides interaction with the various players of the game, indicating, for example, when it is a player's turn to take an action. The user interface for each player may be customized for each player's perspective at the virtual table. For example, the player at the first seat at the table is provided a view different from the second seat, the third seat, etc. As such each player may have a different view of the table, as well as a perspective on the virtual dealer. Thus, when the virtual dealer is indicating that the second seat must act in the game, to the player in the second seat the perspective indicates the virtual dealer is gesturing to that player, while a player in the first seat is provided a different perspective of the virtual dealer indicating to the second seat.

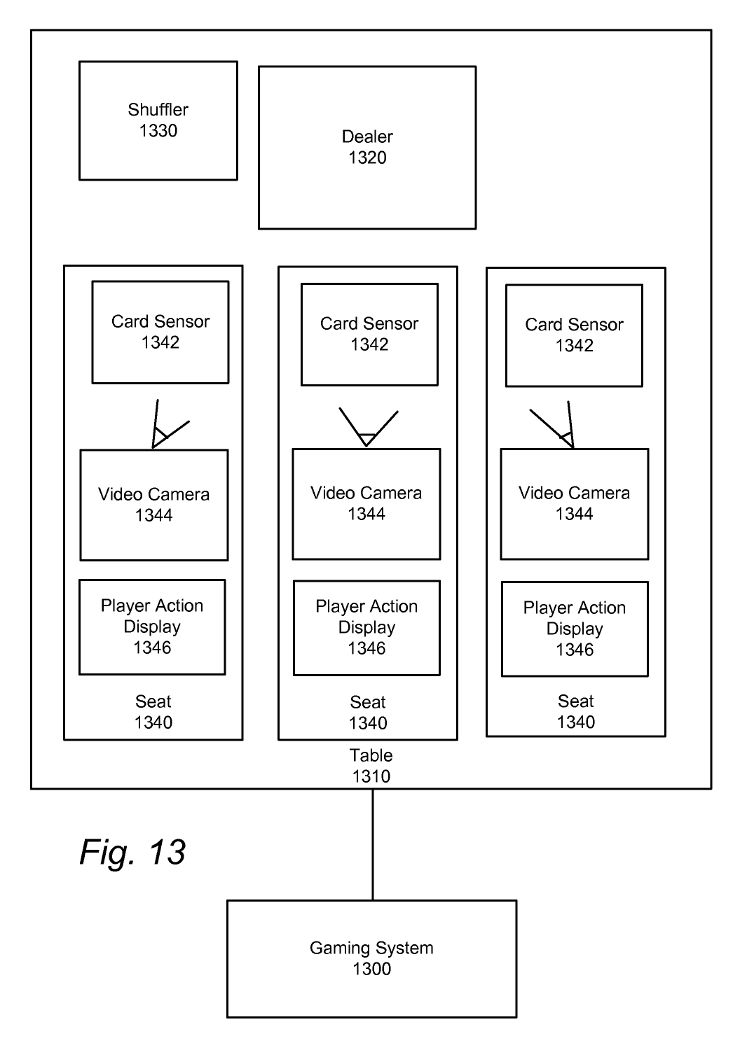

FIG. 13 is a block diagram of a gaming system providing for live dealer play for a user at a remote user device according to one embodiment. In this embodiment, the wagering games described herein are provided to a player on a user device (not shown) by a live dealer 1320 at a table 1310. In this embodiment, the live dealer 1320 and table 1310 provide the game engine functionality to the gaming system 1300 by executing game mechanics and providing game action and results to the gaming system 1300. The live dealer 1320 receives cards from a shuffler 1330 and distributes the cards to players according to the gameplay rules. When players join and leave the game, players join a seat 1340 at the table 1310. The table 1310 includes the number of seats 1340 according to the number of seats 1340 allotted to the particular game being played.

In this embodiment, each seat at the table 1310 includes a card sensor 1342, a video camera 1344, and a player action display 1346. The player at a seat 1340 is provided a view of the table from video camera 1344. The video camera 1344 provides a video feed to the user device operated by the player showing the player action on the table 1310 and provides the player a view of the dealer 1320 and the shuffler 1330. Thus, the player receives a live view of activities at the table 1310 while the user plays the game.

The card sensor 1342 includes positions for the dealer 1320 to place cards as the cards are dealt to the dealer. The card sensor 1342 may be in view of the video camera 1344, or the card sensor 1342 may not be in view of the video camera 1344. When the card sensor 1342 is in view of the video camera 1344, the dealer 1320 may deal the cards to the positions face-up so the video camera 1344 may view the cards dealt to the player. When the card sensor 1342 is not viewable by the player, the card sensor 1342 may be placed underneath the camera and provide the illusion that the dealer 1320 is providing cards to the player, as the cards are dealt underneath the video camera 1344 and leave the video camera's 1344 view. The cards dealt to the player are transmitted to the gaming system 1300 and subsequently the user device and displayed to the player. The particular cards dealt to the player may be determined in various ways. In one embodiment, the shuffler 1330 includes a card reader that identifies particular rank and suit (and any other relevant characteristics) of a card as the card leaves the shuffler. The shuffler may also know the seat that the card will be dealt to. As such, the shuffler 1330 may provide the card information to the gaming system 1300. When the card is dealt to the seat 1340, the card sensor 1342 detects the presence of the card (e.g. by blocking light to a sensor at the card position). The card sensor 1342 indicates the presence of the card to the shuffler 1330 and the shuffler 1330 indicates the card provided to the seat 1340 to the gaming system 1300.

Alternatively, the card sensor 1342 may detect the rank and suit of the card. The card sensor 1342 identifies the cards by a variety of means. In one embodiment, the card sensor 1342 comprises a translucent panel placed over a scanner. When a card is played over the card sensor 1342, the scanner reads the card through the translucent panel and provides the card information to the gaming system 1300. In another embodiment, the card sensor 1342 includes a radio-frequency identification (RFID) reader (or interrogator). In this embodiment, each card includes a RFID tag responsive to the RFID reader, the tag indicating the card's rank and suit when interrogated by the RFID reader. When the dealer places the card on the position of the card for the seat 1340, the RFID reader interrogates the RFID tag in the card and obtains the card's characteristics. The card's characteristics are provided to the gaming system 1300 for communication with the user device of the player at the seat 1340. Other card identification methods may be used by the card sensor 1342 to identify the card placed at seat 1340.

The seat 1340 also includes a player action display 1346. As players place wagers, and execute game actions on the respective user devices, the players' activities are transmitted to the player action display 1346. The player action display 1346 is a visual display for the dealer 1320 of the player's action. For example, the action display may indicate when a user has placed a bet, folded, or interacted with the game according to actions permitted by the game rules. In one embodiment, the player action display 1346 also provides a video feed to the dealer 1320 of a camera at the user device. The camera may be used to show, for example, the user as the user plays the game, thus enabling a face-to-face view of the player to the dealer though the player is not at the table 1310. In one embodiment, the player action display 1346 shows the amount of time since a user has taken an action. The amount of time the user has taken an action is used by the dealer to determine whether to wait for the player or whether to continue with play when the player has been idle. The player actions may also be shown to each user device to indicate the actions taken by other players during the game.

The shuffler 1330 is an automatic card shuffler that shuffles cards for the game being played. The shuffler 1330 includes, in one embodiment, a card reader that indicates individual cards or groups of cards as the cards are dealt by the shuffler 1330. The shuffler 1330 may also be programmed for the rules of the game being dealt and may be able to determine, for example, the particular cards to be dealt to individual players. The shuffler 1330 provides the card information to the gaming system 1300. Thus, the gaming system 1300 using the table 1310 allows a user to be remotely located at a user device while maintaining a live casino feel by viewing action at the table 1310. Since actual cards are shuffled by shuffler 1330 and a dealer 1320 deals the cards, the user is able to enjoy a live game playing format. The dealt cards are provided to the user device operated by the user and the user's actions are provided to the table 1310 by the player action display 1346. The dealer 1320 uses the player action display 1346 to determine what actions to take to complete the game. Because the player has a view of the dealer 1320, the dealer 1320 can also interact directly with players and respond to particular players. For example, the dealer may gesture to a particular player that it is that player's turn to perform an action in the game. In addition, the user may communicate with the dealer 1320, either by speaking to the dealer using a microphone, or the player may provide a message to the dealer through the player action display 1346. For example, a player who does not know how to play the game may type a query into the user device, and query may appear in the player action display 1346, and the dealer 1320 may explain the game rules to the video camera 1344 of the seat 1340 for the player requesting the information. Thus, players can play the wagering games of this description in an environment simulating live play.

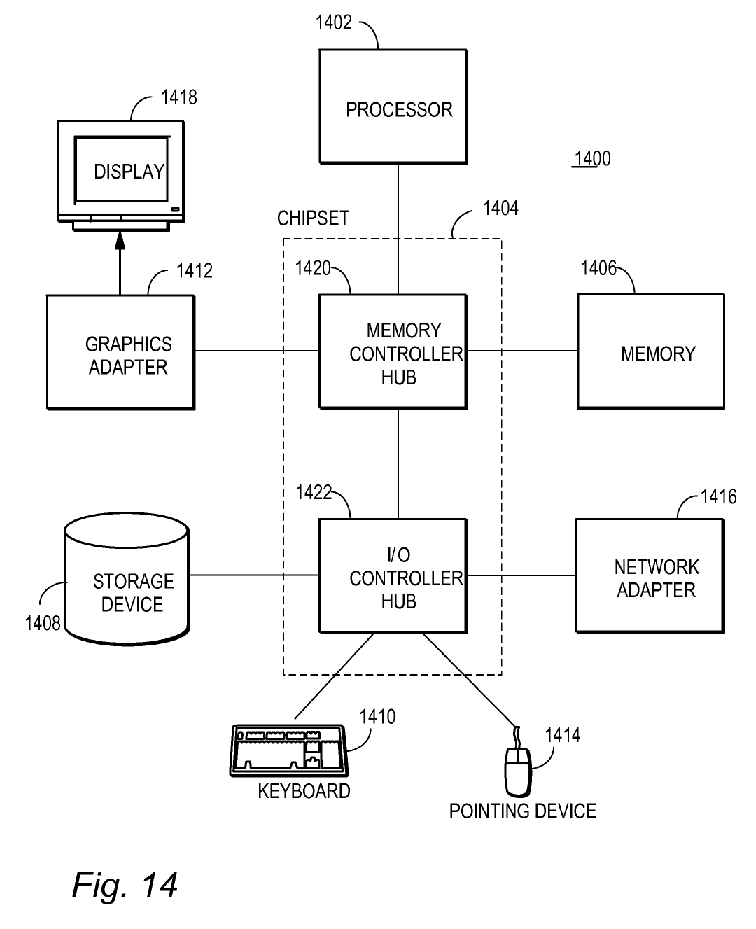

FIG. 14 is a high-level block diagram of a computer 1400 for acting as a gaming system 1100, 1200, or 1300 according to one embodiment. Illustrated are at least one processor 1402 coupled to a chipset 1404. Also coupled to the chipset 1404 are a memory 1406, a storage device 1408, a keyboard 1410, a graphics adapter 1412, a pointing device 1414, and a network adapter 1416. A display 1418 is coupled to the graphics adapter 1412. In one embodiment, the functionality of the chipset 1404 is provided by a memory controller hub 1420 and an I/O controller hub 1422. In another embodiment, the memory 1406 is coupled directly to the processor 1402 instead of the chipset 1404.

The storage device 1408 is any non-transitory computer-readable storage medium, such as a hard drive, compact disk read-only memory (CD-ROM), DVD, or a solid-state memory device. The memory 1406 holds instructions and data used by the processor 1402. The pointing device 1414 may be a mouse, track ball, or other type of pointing device, and is used in combination with the keyboard 1410 to input data into the computer system 1400. The graphics adapter 1412 displays images and other information on the display 1418. The network adapter 1416 couples the computer system 1400 to a local or wide area network.

A computer 1400 can have different and/or other components than those shown in FIG. 14. In addition, the computer 1400 can lack certain illustrated components. In one embodiment, a computer 1400 acting as a gaming system lacks a keyboard 1410, pointing device 1414, graphics adapter 1412, and/or display 1418. Moreover, the storage device 1408 can be local and/or remote from the computer 500 (such as embodied within a storage area network (SAN)).

A gaming system may comprise several such computers 1400. The gaming system may include load balancers, firewalls, and various other components for assisting the gaming system to provide services to a variety of user devices.

The computer 1400 is adapted to execute computer program modules for providing functionality described herein. As used herein, the term “module” refers to computer program logic utilized to provide the specified functionality. Thus, a module can be implemented in hardware, firmware, and/or software. In one embodiment, program modules are stored on the storage device 1408, loaded into the memory 1406, and executed by the processor 1402.

Embodiments of the entities described herein can include other and/or different modules than the ones described here. In addition, the functionality attributed to the modules can be performed by other or different modules in other embodiments. Moreover, this description occasionally omits the term “module” for purposes of clarity and convenience.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations or transformation of physical quantities or representations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “determining” or the like, refer to the action and processes of a computer system, or similar electronic computing device (such as a specific computing machine), that manipulates and transforms data represented as physical (electronic) quantities within the computer system memories or registers or other such information storage, transmission or display devices.

Certain aspects of the embodiments include process steps and instructions described herein in the form of an algorithm. It should be noted that the process steps and instructions of the embodiments can be embodied in software, firmware or hardware, and when embodied in software, could be downloaded to reside on and be operated from different platforms used by a variety of operating systems. The embodiments can also be in a computer program product which can be executed on a computing system.

The embodiments also relates to an apparatus for performing the operations herein. This apparatus may be specially constructed for the purposes, e.g., a specific computer, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Memory can include any of the above and/or other devices that can store information/data/programs and can be transient or non-transient medium, where a non-transient or non-transitory medium can include memory/storage that stores information for more than a minimal duration. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the method steps. The structure for a variety of these systems will appear from the description herein. In addition, the embodiments are not described with reference to any particular programming language. It will be appreciated that a variety of programming languages may be used to implement the teachings of the embodiments as described herein, and any references herein to specific languages are provided for disclosure of enablement and best mode.

In addition, the language used in the specification has been principally selected for readability and instructional purposes, and may not have been selected to delineate or circumscribe the inventive subject matter. Accordingly, the disclosure of the embodiments is intended to be illustrative, but not limiting, of the scope of the embodiments, which is set forth in the claims.

While particular embodiments and applications have been illustrated and described herein, it is to be understood that the embodiments are not limited to the precise construction and components disclosed herein and that various modifications, changes, and variations may be made in the arrangement, operation, and details of the methods and apparatuses of the embodiments without departing from the spirit and scope of the embodiments as defined in the appended claims.

What is claimed:

1. A computer-implemented method of playing a wagering game, comprising:
receiving, by a processor from a user device, at least one ante wager associable with a player to participate in the wagering game;
dealing, by the processor, at least one card to associable with a player position and at least one card to a dealer position, each at least one card forming a partial hand;
dealing, by the processor, at least one community card;
receiving, by the processor, either a check or a first play wager from the user device associable with the player that is a multiple of the amount of the ante, after the at least one card associable with the player's partial hand is displayed;
revealing, by the processor to the user device, the at least one community card by the dealer;
receiving, by the processor from the user device associable with the player, either a play wager that is a multiple of the amount of the ante and is less than a maximum multiple of the ante wager allowable for the first play wager if there has not been a previously made play wager on the player hand associable with the play, or a fold; and
paying a play wager associable with the player whose player hand poker ranking exceeds the dealer poker hand ranking.

2. The method of claim 1, wherein the partial hand is formed of two cards and five community cards are dealt.

3. The method of claim 1, wherein the poker ranking is based on a best five-card poker hand from a partial hand of two player cards and five community cards.

4. The method of claim 1, wherein the community cards are revealed in at least two separate segments and receiving at least one play wager associable with the player after revealing each segment of community cards.

5. The method of claim 1, wherein the user device associable with the player is provided with at least three opportunities to make a play wager and, with successively revealed cards, lowering the allowable wager multiples as the game progresses.

6. The method of claim 1, further comprising determining at least one winning player hand of the game against the dealer in the event of the dealer qualifying with a minimum hand ranking.

7. The method of claim 1, further comprising allowing the at least one player to place a side wager on the occurrence of predetermined winning hands.

8. The method of claim 7, including determining the predetermined winning hands on the basis of a hand of five cards.

9. The method of claim 1, further comprising allowing the at least one player to place a blind wager that pays on the occurrence of at least one predetermined winning hand.

10. The method of claim 1, wherein the multiples on the first play wager ranges between 1× and 10× the ante wager.

11. The method of claim 1, wherein the multiples on the first play wager ranges between 1× and 4× the ante wager.

12. A computer-implemented method of playing a wagering game, comprising:
receiving, by a processor from a first user device associable with a first player and a second user device associable with a second player, an ante wager associable with the first player and an ante wager associable with the second player placed in a first betting area of a virtual table and a second betting area of the virtual table;
dealing, by the processor, at least one card associable with a first player position, at least one card associable with a second player position, and at least one card to a dealer position, each at least one card forming a partial hand;
dealing, by the processor, at least one community card;
providing the dealt cards to the first and second user devices for display to the first and second player;
receiving either a check or a first play wager associable with the first and second player that is a multiple of the amount of the ante, after the at least one card of the first and second player's partial hand is provided;
revealing, by the processor, at least one community card to the first user device and second user device;
receiving from the first and second user device either a play wager associable with the first or second player that is a multiple of the amount of the ante and is less than a maximum multiple of the ante wager allowable for the first play wager if the player has not previously made a play wager, or a fold;
providing an indication of the betting, play, fold, and check actions associable with the first player to the second user device; and
paying a play wager associable with the player whose player hand poker ranking exceeds the dealer hand poker ranking.

13. The method of claim 12, wherein the partial hand is formed of two cards and five community cards are dealt.

14. The method of claim 12, wherein the poker ranking is based on a best five-card poker hand from a partial hand of two player cards and five community cards.

15. The method of claim 12, wherein the community cards are revealed in at least two separate segments and at least one play wager may be associable with the first or second player after revealing each segment of community cards.

16. The method of claim 12, wherein the first and second user devices are provided with at least three opportunities to make a play wager and, with successively revealed cards, lowering the allowable wager multiples as the game progresses.

17. The method of claim 12, further comprising determining at least one winning player hand of the game against the dealer in the event of the dealer qualifying with a minimum hand ranking.

18. The method of claim 12, further comprising allowing a side wager associable with the first or second player on the occurrence of predetermined winning hands.

19. The method of claim 18, including determining the predetermined winning hands on the basis of a hand of five cards.

20. The method of claim 12, further comprising receiving a blind wager associable with the first or second player that pays on the occurrence of at least one predetermined winning hand.

21. The method of claim 12, wherein the multiples on the first play wager ranges between 1× and 10× the ante wager.

22. The method of claim 12, wherein the multiples on the first play wager ranges between 1× and 4× the ante wager.

23. A computer-implemented method of playing a wagering game, comprising:
receiving, by a processor from a user device, an ante wager associable with a player;
providing an indication of the ante wager on a display;
receiving, from a card sensor, an indication of at least one card dealt to a player position associable with the player and at least one card dealt to a dealer position, each at least one card forming a partial hand;
receiving, from the card sensor, an indication of at least one community card dealt to a community position;
providing, to the user device, an indication of the dealt cards to the player position and the community position;
receiving, from the user device, an election of either a check or a first play wager associable with the player that is a multiple of the amount of the ante, after the indication of the dealt cards is provided to the user device;
receiving, from the card sensor, an indication of at least one community card revealed in the community position;
receiving, from the user device, an election associable with the player to either place a play wager that is a multiple of the amount of the ante and is less than a maximum multiple of the ante wager allowable for the first play wager if no play wager is previously associable with the player, or a fold; and
paying a play wager associable with the player whose player hand poker ranking exceeds the dealer poker hand ranking.

24. The method of claim 23, wherein the partial hand is formed of two cards and five community cards are dealt.

25. The method of claim 23, wherein the hand poker ranking is based on a best five-card poker hand from a partial hand of two player cards and five community cards.

26. The method of claim 23, wherein the community cards are revealed in at least two separate segments and at least one play wager associable with the player is allowed after revealing each segment of community cards.

27. The method of claim 23, wherein a play wager associable with the player may be received on at least three opportunities and, with successively revealed cards, lowering the allowable wager multiples as the game progresses.

28. The method of claim 23, further comprising determining at least one winning player hand of the game against the dealer in the event of the dealer qualifying with a minimum hand ranking.

29. The method of claim 23, further comprising allowing the at least one player to place a side wager on the occurrence of predetermined winning hands.

30. The method of claim 29, including determining the predetermined winning hands on the basis of a hand of five cards.

31. The method of claim 23, further comprising receiving a blind wager associable with the player that pays on the occurrence of at least one predetermined winning hand.

32. The method of claim 23, wherein the multiples on the first play wager ranges between 1× and 10× the ante wager.

33. The method of claim 23, wherein the multiples on the first play wager ranges between 1× and 4× the ante wager.
